(19) United States
(12) Patent Application Publication
(10) Pub. No.: US 2010/0242484 A1
(43) Pub. Date: Sep. 30, 2010

(54) APPARATUS AND METHOD FOR COOLING GAS TURBINE ENGINE COMBUSTORS

(76) Inventors: Baha Mahmoud Suleiman, Hamilton, OH (US); Ting-Yu Tu, West Chester, OH (US); David Graham William Fargher, Fairfield, OH (US); William Thaddeus Houchens, Loveland, OH (US)

Correspondence Address: JOHN S. BEULICK (12729);C/O ARMSTRONG TEASDALE LLP, 7700 FORSYTH BOULEVARD, SUITE 1800, ST. LOUIS, MO, 63105, US

(21) Appl. No.: 12/414,820

(22) Filed: Mar. 31, 2009

(51) Int. Cl. F02C 1/00; B64D 33/04

(52) U.S. Cl. 60/748; 239/127.1

(57) ABSTRACT

An apparatus and method fabricating a deflector-flare cone for a combustor is provided. The combustor includes an air swirler annular about a centerline axis of the combustor wherein the swirler includes an annular exit downstream of the swirler. The deflector-flare cone includes a single annular body including an engagement end configured to support the deflector-flare cone, an annular divergent portion extending downstream from the engagement end. The annular divergent portion includes a radially outer annular deflector portion and a radially inner annular flare cone portion that are separated by an annular gap extending between the deflector portion and the flare cone portion. The deflector-flare cone includes a plurality of cooling passages extending through the single annular body of the deflector-flare cone. The plurality of cooling passages are spaced circumferentially about the centerline axis and are configured to be coupled in flow communication with a cooling fluid source.

### BACKGROUND OF THE INVENTION

This application relates generally to gas turbine engines and, more particularly, to combustors for gas turbine engines.

At least some known combustors include at least one mixer assembly coupled to a combustor liner that defines a combustion zone. Fuel injectors are coupled to the combustor in flow communication with the mixer assembly for supplying fuel to the combustion zone. Specifically, in such designs, fuel enters the combustor through the mixer assembly. The mixer assembly is coupled to the combustor liner by a dome plate or a spectacle plate.

At least some known mixer assemblies include a flare cone. Generally, the flare cone is divergent and extends radially outward from a centerline axis of the combustor to facilitate mixing the air and fuel, and to facilitate spreading the mixture radially outwardly into the combustion zone. A divergent deflector extends circumferentially around and radially outward from the flare cone. The deflector, sometimes referred to as a splash plate, facilitates preventing hot combustion gases produced within the combustion zone from impinging upon the dome plate.

During operation, fuel discharged to the combustion zone may form a fuel-air mixture along the flare cone and the deflector. This fuel-air mixture may combust resulting in high gas temperatures. Prolonged exposure to the increased temperatures may increase a rate of oxidation formation on the flare cone, and may result in deformation of the flare cone and the deflector.

To facilitate reducing operating temperatures of the flare cone and the deflector, at least some known combustor mixer assemblies supply convective cooling air via air injectors defined within the flare cone. Specifically, in such combustors, the cooling air is supplied into a gap extending circumferentially around the combustor centerline axis between the flare cone and the deflector.

Such cooled deflector assemblies are formed of separate flare cones and deflectors, which are subsequently coupled together, for example, by brazing to form a unitary assembly having the flare cone integral with the deflector. However, forming the deflector and flare cone separately increases the combustor part count and coupling the deflector and flare cone together is labor intensive and prone to possible manufacturing tolerance errors.

### BRIEF DESCRIPTION OF THE INVENTION

In one embodiment, a deflector-flare cone for a combustor includes a single annular body including an engagement end configured to support the deflector-flare cone, an annular divergent portion extending downstream from the engagement end. The annular divergent portion includes a radially outer annular deflector portion and a radially inner annular flare cone portion that are separated by an annular gap extending between the deflector portion and the flare cone portion. The deflector-flare cone includes a plurality of cooling passages extending through the single annular body of the deflector-flare cone. The plurality of cooling passages are spaced circumferentially about the centerline axis and are configured to be coupled in flow communication with a cooling fluid source.

In another embodiment, a method of forming a deflector-flare cone includes forming a deflector-flare cone blank from a single piece of material, forming a circumferential groove in a downstream end of said deflector-flare cone blank forming a radially outer divergent deflector portion and a radially inner divergent flare cone portion separated by said gap, and forming a plurality of cooling passages spaced circumferentially about said deflector-flare cone from an upstream end to said gap.

In yet another embodiment, a gas turbine engine includes a compressor configured to transmit compressed air, and a combustor coupled in flow communication with the compressor. The combustor includes a single-piece deflector-flare cone wherein the deflector-flare cone includes a deflector portion and a flare cone portion separated from the deflector portion by a groove machined into a downstream end of the deflector-flare cone. The deflector-flare cone comprises a plurality of cooling passages extending through the deflector-flare cone from an upstream end supplied with compressed air by the compressor to the groove. The plurality of cooling passages are spaced circumferentially about a centerline axis of the deflector-flare cone.

### BRIEF DESCRIPTION OF THE DRAWINGS

FIGS. 1-6 show exemplary embodiments of the apparatus and method described herein.

FIG. 1 is a schematic view of an exemplary gas turbine engine including a fan assembly, a booster, a high-pressure compressor, and a combustor in accordance with an exemplary embodiment of the present invention;

FIG. 2 is a cross-sectional view of combustor used in the gas turbine engine shown in FIG. 1;

FIG. 3 is an enlarged view of a portion of the combustor taken along the area 3 shown in FIG. 2;

FIG. 4 is an enlarged cross-sectional view of a portion of a known deflector-flare cone assembly;

FIG. 5 is a cross-sectional view of a portion of the deflector-flare cone shown in FIG. 2 in accordance with an exemplary embodiment of the present invention; and

FIG. 6 is a flow chart of an exemplary method of forming a deflector-flare cone in accordance with an embodiment of the present invention.

### DETAILED DESCRIPTION OF THE INVENTION

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

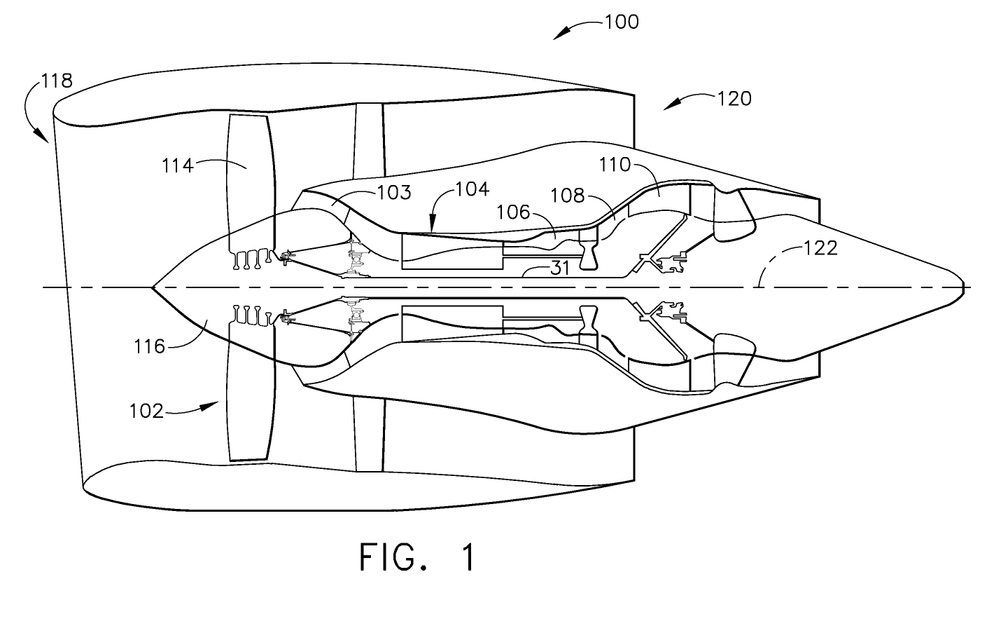

FIG. 1 is a schematic view of an exemplary gas turbine engine 100 including a fan assembly 102, a booster 103, a high-pressure compressor 104, and a combustor 106. Fan assembly 102, booster 103, compressor 104, and combustor 106 are coupled in flow communication. Engine 100 also includes a high-pressure turbine 108 coupled in flow communication with combustor 106 and a low-pressure turbine 110. Fan assembly 102 includes an array of fan blades 114 extending radially outward from a rotor disc 116. Engine 100 has an intake 118 and an exhaust 120. Engine 100 further includes a centerline 122 about which fan 102, booster 103, compressor 104, and turbines 108 and 110 rotate.

In operation, air enters engine 100 through intake 118 and is channeled through fan assembly 102 into booster 103. Compressed air is discharged from booster 103 into high-pressure compressor 104. Highly compressed air is channeled from compressor 104 to combustor 106 where fuel is mixed with air and the mixture is combusted within combustor 106. High temperature combustion gases generated are channeled to turbines 108 and 110. Turbine 108 drives compressor 104, and turbine 110 drives fan assembly 102 and booster 103. Combustion gases are subsequently discharged from engine 100 via exhaust 120.

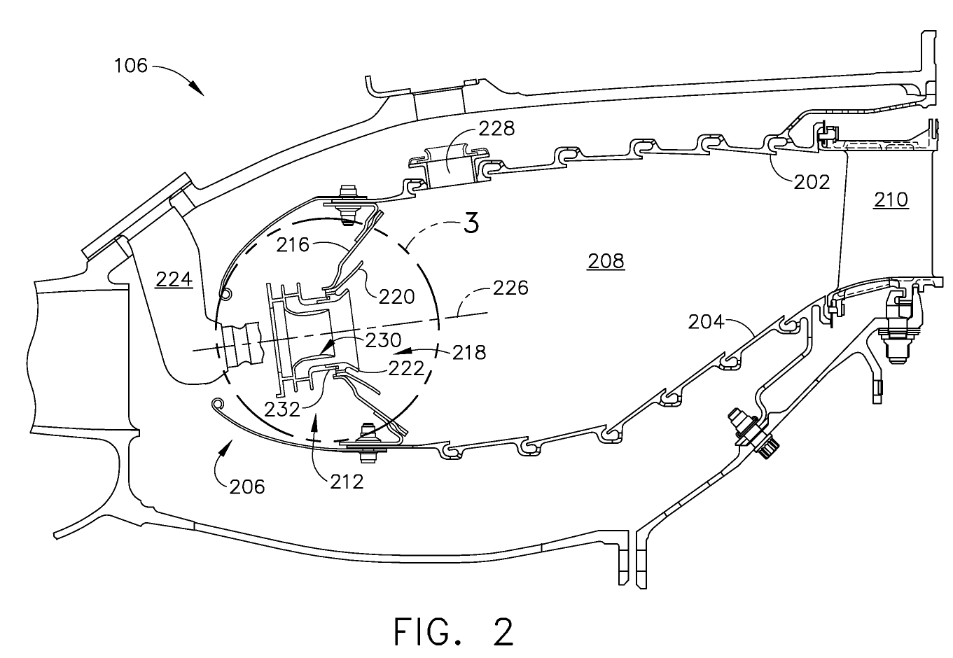

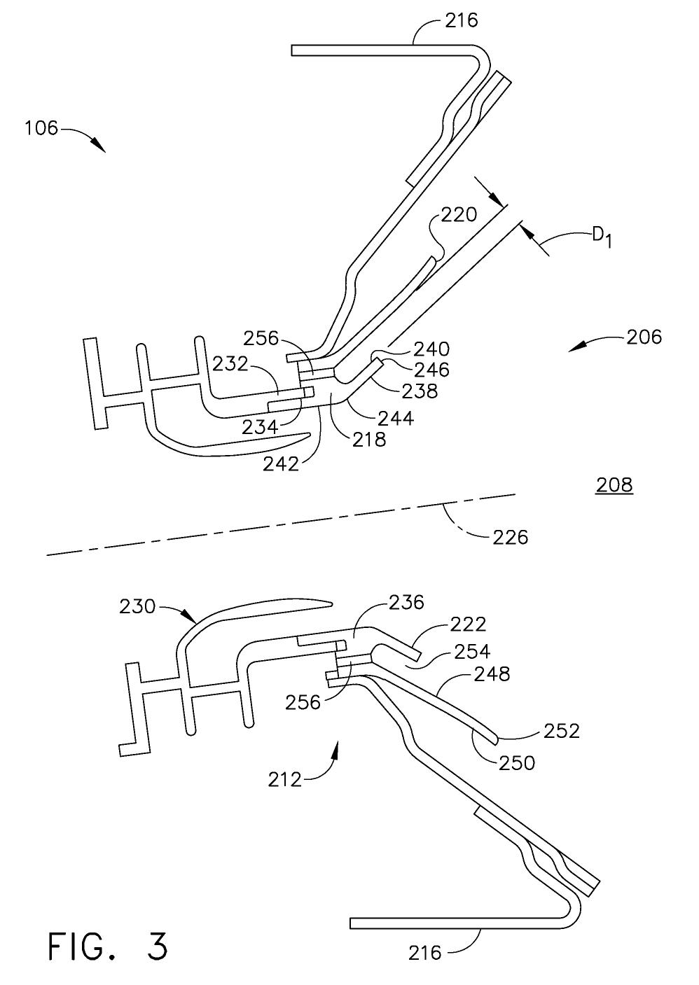

FIG. 2 is a cross-sectional view of combustor 106 used in gas turbine engine 100 (shown in FIG. 1). FIG. 3 is an enlarged view of a portion of combustor 106 taken along area 3 (shown in FIG. 2). Combustor 106 includes an annular outer liner 202, an annular inner liner 204, and a domed end 206 that extends between outer and inner liners 202 and 204, respectively. Outer liner 202 and inner liner 204 define a combustion chamber 208.

Combustion chamber 208 is generally annular in shape and is disposed between liners 202 and 204. Outer and inner liners 202 and 204 extend to a turbine nozzle 210 disposed downstream from combustor domed end 206.

In the exemplary embodiment, combustor domed end 206 includes an annular dome assembly 212 arranged in a single annular configuration. In another embodiment, combustor domed end 206 includes a dome assembly 212 arranged in a double annular configuration. In a further embodiment, combustor domed end 206 includes a dome assembly 212 arranged in a triple annular configuration. Combustor dome assembly includes a dome plate or spectacle plate 216 and a deflector-flare cone 218. Deflector-flare cone 218 is a single one-piece member that is machined to include a radially divergent deflector portion 220 and a radially divergent flare cone portion 222. In the exemplary embodiment, deflector-flare cone 218 is fabricated in a single piece using a casting process and then machined to form the features of deflector portion 220 and flare cone portion 222. In an alternative embodiment, deflector-flare cone 218 is fabricated in a single piece using a forging process and then machined to form the features of deflector portion 220 and flare cone portion 222. In another alternative embodiment, deflector-flare cone 218 is fabricated in a single piece using another process that provides a one-piece blank that includes extra material outside final dimensional tolerances and then machined to form the features of deflector portion 220 and flare cone portion 222.

Combustor 106 is supplied fuel via a fuel injector 224 connected to a fuel source (not shown) and extending through combustor domed end 206. More specifically, fuel injector 224 extends through dome assembly 212 and discharges fuel in a direction (not shown) that is substantially concentric with respect to a combustor center longitudinal axis of symmetry 226. Combustor 106 also includes a fuel igniter 228 that extends into combustor 106 downstream from fuel injector 224.

Combustor 106 also includes an annular air swirler 230 having an annular exit 232 that extends substantially symmetrically about combustor center longitudinal axis of symmetry 226. Exit 232 includes mating surface 234 configured to engage a complementary engagement end 236 of deflector-flare cone 218. Deflector-flare cone 218 couples to exit 232 using mating surface 234 and extends downstream from exit 232. Flare cone portion 222 includes a radially inner flow surface 238 and a radially outer surface 240. An inner surface 242 of deflector-flare cone 218 extends downstream from engagement end 236 to an elbow 244, before extending divergently outward from elbow 244 to a trailing end 246 of flare cone portion 222.

Deflector portion 220 includes a radially inner flow surface 248 and a radially outer surface 250. Deflector portion 220 extends downstream from engagement end 236 and divergently outward to a trailing end 252 of deflector portion 220.

A gap 254 is formed between deflector portion 220 and flare cone portion 222 using a machining process during fabrication of deflector-flare cone 218. Gap 254 provides an annular space having a width D₁ for directing cooling fluid about outer surface 240 and radially inner flow surface 248.

A plurality of circumferentially spaced cooling passages 256 are formed through deflector-flare cone 218. Specifically, cooling passages 256 extend substantially axially through deflector-flare cone 218 in a direction that is substantially parallel to a combustor center longitudinal axis of symmetry 226. In an alternative embodiment, cooling passages 256 are oriented non-parallel with respect to combustor center longitudinal axis of symmetry 226. Additionally, in various embodiments, cooling passages 256 are spaced non-uniformly around combustor center longitudinal axis of symmetry 226 to provide a variable amount of cooling to various areas of deflector portion 220 and/or flare cone portion 222. Cooling passages 256 discharge cooling air therethrough at a reduced pressure for cooling of deflector-flare cone 218. In one embodiment, the cooling air is compressor air. In the exemplary embodiment, cooling passages 256 are formed using an electro-discharge machining (EDM) process.

During operation, cooling air is supplied to deflector-flare cone 218 through cooling passages 256. Cooling passages 256 facilitate providing a continuous flow of cooling air to be discharged at a reduced air pressure for impingement cooling of flare cone portion 222. The reduced air pressure facilitates improved cooling and backflow margin for the impingement cooling of flare cone portion 222. Furthermore, the cooling air enhances convective heat transfer and facilitates reducing an operating temperature of flare cone portion 222, which facilitates extending a useful life of flare cone portion 222, while reducing a rate of oxidation formation of flare cone portion 222.

Furthermore, as cooling air is discharged through cooling passages 256, deflector divergent portion 220 is film cooled. More specifically, cooling passages 256 supply deflector divergent portion inner surface 248 with film cooling. Because cooling passages 256 are spaced circumferentially through deflector-flare cone 218, film cooling is directed along deflector inner surface 248 substantially circumferentially around flare cone portion 222. In addition, because cooling passages 256 facilitate substantially uniform cooling flow, deflector-flare cone 218 facilitates optimizing film cooling while reducing mixing of the cooling air with combustion air, which thereby facilitates reducing an adverse effect of flare cooling on combustor emissions.

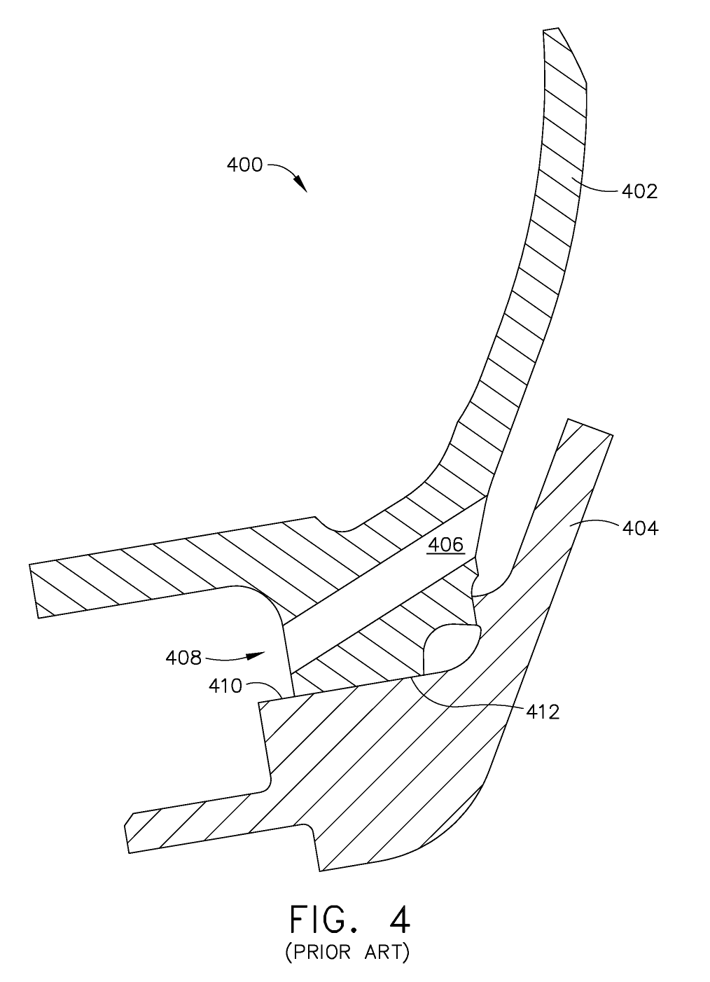

FIG. 4 is an enlarged cross-sectional view of a portion of a known deflector-flare cone assembly 400. Deflector-flare cone assembly 400 includes a deflector member 402 and a separately formed flare cone member 404. Typically, deflector member 402 is cast, machined to final dimensions, and a plurality of cooling holes 406 are formed through a mating flange 408 of deflector member 402. Flare cone member 404 is also cast and machined to final dimensions. Deflector member 402 and flare cone member 404 are then joined along a radially outer surface 410 of flare cone member 404 and a radially inner surface 412 of mating flange 408 using, for example, but not limited to a brazing process. Fitting deflector member 402 and flare cone member 404 together and the brazing process increase the possibility of manufacturing and tolerance errors affecting the operation of the combustor.

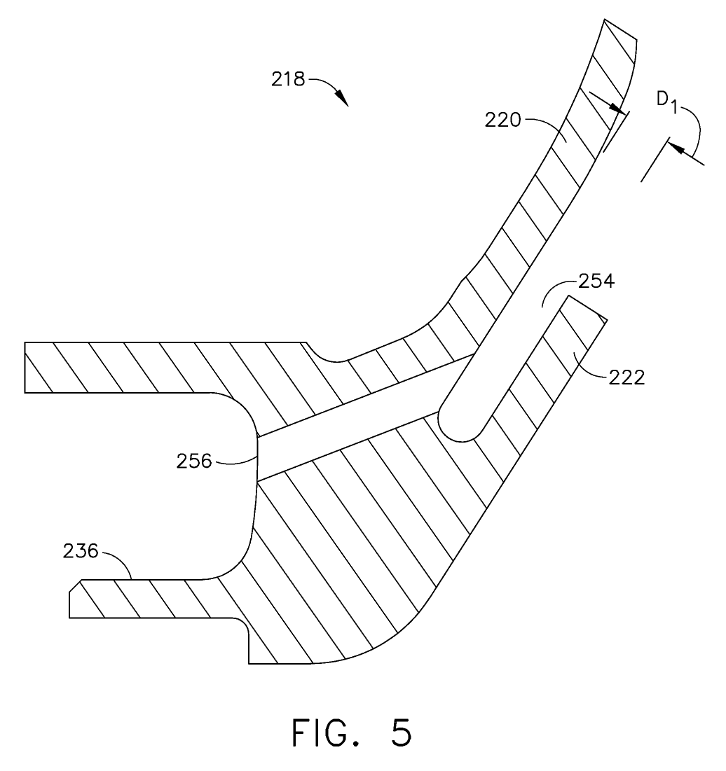

FIG. 5 is a cross-sectional view of a portion of deflector-flare cone 218 in accordance with an exemplary embodiment of the present invention. In the exemplary embodiment, deflector-flare cone 218 is formed by, for example, a casting process. Machining of deflector-flare cone 218 forms deflector portion 220 and a flare cone portion 222. Annular gap 254 is formed during a further machining process. A plurality of circumferentially spaced cooling passages 256 are formed through deflector-flare cone 218. In the exemplary embodiment, cooling passages 256 are formed using an electro-discharge machining (EDM) process. Fabricating deflector-flare cone 218 from a single cast piece reduces the number of machining operations required to form deflector-flare cone 218 and completely eliminates the brazing process that is needed to join the deflector portion and the flare cone portion when the deflector portion and the flare cone portion are formed separately.

During operation, cooling air is supplied to deflector-flare cone 218 through cooling passages 256. Cooling passages 256 facilitate providing a continuous flow of cooling air to be discharged at a reduced air pressure for impingement cooling of flare cone portion 222. Furthermore, the cooling air enhances convective heat transfer and facilitates reducing an operating temperature of flare cone portion 222, which facilitates extending a useful life of flare cone portion 222, while reducing a rate of oxidation formation of flare cone portion 222.

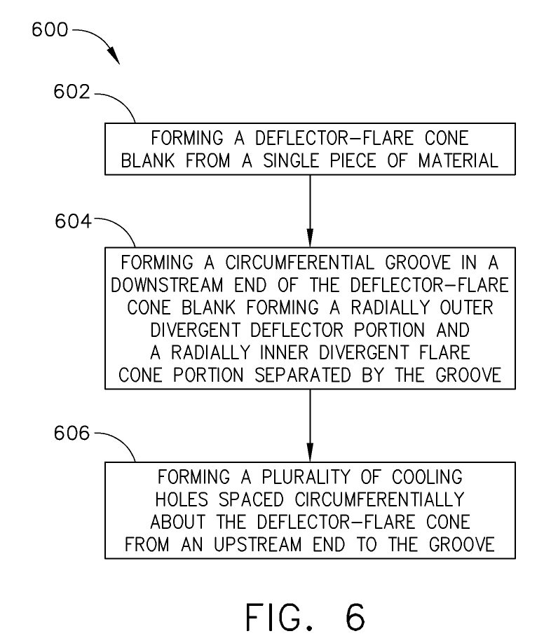

FIG. 6 is a flow chart of an exemplary method 600 of forming a deflector-flare cone in accordance with an embodiment of the present invention. In the exemplary embodiment, method 600 includes forming 602 a deflector-flare cone blank from a single piece of material. The deflector-flare cone blank may be formed using a casting, forging, or other process of providing the deflector-flare cone blank to rough dimensions suitable for further machining to final dimensional tolerances. Method 600 also includes forming 604 a circumferential groove in a downstream end of the deflector-flare cone blank forming a radially outer divergent deflector portion and a radially inner divergent flare cone portion separated by the gap. Because the deflector-flare cone blank is formed of a single piece, a deflector portion and a flare cone portion are formed by a single machining process to cut a groove circumferentially about the divergent downstream end of the deflector-flare cone blank thereby forming the deflector portion, the flare cone portion, and a gap therebetween. Method 600 includes forming 606 a plurality of cooling passages spaced circumferentially about the deflector-flare cone from an upstream end to the gap. The cooling passages are machined through the deflector-flare cone from an upstream side to the gap between the deflector portion and the flare cone portion. The cooling passages channel compressor air from an upstream channel to the gap to be distributed about the deflector portion and the flare cone portion for cooling during operation. In various embodiments, the cooling passages may be distributed non-uniformly about the circumference of the deflector-flare cone to provide more or less cooling as needed to certain portions of the deflector portion and the flare cone portion.

The methods and apparatuses for a combustor described herein facilitate operation of a gas turbine. More specifically, the single-piece combustor deflector-flare cone as described above facilitates an efficient and effective combustor cooling mechanism. In addition, the robust single-piece combustor deflector-flare cone facilitates an extended operational life expectancy over prior art separate combustor deflectors and flare cones. Such combustor deflector-flare cones also facilitate gas turbine fabrication time and cost, and reduced maintenance costs and gas turbine outages.

Exemplary embodiments of single-piece cast and machined combustor deflector-flare cones as associated with gas turbines are described above in detail. The methods, apparatus, and systems are not limited to the specific embodiments described herein or to the specific illustrated gas turbines.

The above-described embodiments of an apparatus and method for fabricating a deflector-flare cone provides a cost-effective and reliable means for improved manufacturing of gas turbine engine components. More specifically, the apparatus and method described herein facilitate reducing a part count and fabrication steps. As a result, the apparatus and method described herein facilitate manufacturing gas turbine engine components in a cost-effective and reliable manner.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A deflector-flare cone for a combustor comprising an air swirler annular about a centerline axis of the combustor, the swirler having an annular exit downstream of the swirler, said deflector-flare cone comprising a single annular body comprising:
an engagement end configured to support the deflector-flare cone;
an annular divergent portion extending downstream from said engagement end, said annular divergent portion comprising a radially outer annular deflector portion and a radially inner annular flare cone portion that are separated by an annular gap extending between said deflector portion and said flare cone portion; and
a plurality of cooling passages extending through said single annular body of said deflector-flare cone, said plurality of cooling passages are spaced circumferentially about the centerline axis and configured to be coupled in flow communication with a cooling fluid source.

2. A deflector-flare cone in accordance with claim 1 wherein said engagement end comprises:
a coupling joint configured to engage the annular exit; and
a radially outer flange surface configured to engage a domeplate of the combustor.

3. A deflector-flare cone in accordance with claim 1 wherein said gap comprises a machined annular space between said deflector portion and said flare cone portion.

4. A deflector-flare cone in accordance with claim 1 wherein said plurality of cooling passages extend through said single annular body from an upstream cooling fluid source to said gap.

5. A deflector-flare cone in accordance with claim 1 wherein said plurality of cooling passages are spaced non-uniformly about the centerline axis to supply a variable amount of cooling to said deflector portion.

6. A deflector-flare cone in accordance with claim 1 wherein said gap comprises a substantially constant width.

7. A deflector-flare cone in accordance with claim 1 wherein said deflector-flare cone comprises a single piece.

8. A method of forming a deflector-flare cone, said method comprising:
forming a deflector-flare cone blank from a single piece of material;
forming a circumferential groove in a downstream end of the deflector-flare cone blank forming a radially outer divergent deflector portion and a radially inner divergent flare cone portion separated by the groove; and
forming a plurality of cooling passages spaced circumferentially about the deflector-flare cone from an upstream end to the groove.

9. A method in accordance with claim 8 wherein forming a plurality of cooling passages comprises spacing the cooling passages non-uniformly about a centerline axis of the deflector-flare cone.

10. A method in accordance with claim 8 wherein forming a plurality of cooling passages comprises grouping the plurality of cooling passages in an area where more cooling is desired.

11. A method in accordance with claim 8 wherein forming a plurality of cooling passages comprises sizing the plurality of cooling passages according to an amount of cooling desired proximate the cooling passages.

12. A method in accordance with claim 8 wherein forming a plurality of cooling passages comprises orienting the plurality of cooling passages to channel a flow of cooling fluid to provide impinging flow on to the flare cone portion.

13. A method in accordance with claim 8 further comprising machining a radially outer mating flange complementary to a domeplate of a combustor.

14. A method in accordance with claim 8 further comprising machining a radially inner mating flange complementary to an exit end of a combustor swirler.

15. A method in accordance with claim 8 wherein forming a circumferential groove comprises forming a circumferential groove a substantially constant width between the deflector portion and the flare cone portion.

16. A gas turbine engine comprising:
a compressor configured to transmit compressed air; and
a combustor coupled in flow communication with said compressor, said combustor comprising a single-piece deflector-flare cone, said deflector-flare cone comprising a deflector portion and a flare cone portion separated from said deflector by a groove machined into a downstream end of the deflector-flare cone, said deflector-flare cone comprises a plurality of cooling passages extending through the deflector-flare cone from an upstream end supplied with compressed air by the compressor to the groove, said plurality of cooling passages spaced circumferentially about a centerline axis of said deflector-flare cone.

17. A gas turbine engine in accordance with claim 16 wherein said flare cone portion is radially inward from said deflector portion such that a substantially annular gap is defined therebetween.

18. A gas turbine engine in accordance with claim 17 wherein said gap comprises a substantially constant width.

19. A gas turbine engine in accordance with claim 16 wherein plurality of cooling passages are spaced non-uniformly about the centerline axis.

20. A gas turbine engine in accordance with claim 16 wherein said single-piece deflector-flare cone is braze-free.
